(19) United States
(12) Patent Application Publication
(10) Pub. No.: US 2025/0150101 A1
(43) Pub. Date: May 8, 2025

(54) MODULAR AND SCALABLE SWITCH MATRIX TOPOLOGY

(71) Applicant: BAE SYSTEMS Information and Electronic Systems Integration Inc., Nashua, NH (US)

(72) Inventors: Jake H. Rivard, Uxbridge, MA (US); Robert P. Taylor, Bedford, NH (US); Randall T. Enderby, Derry, NH (US); William H. Cantrell, Aubrey, TX (US); Mark Tinch, Rhome, TX (US); John M. Edwards, Dallas, TX (US); Mark E. Hughes, Flower Mound, TX (US); Andrew G. Macdonald, Dallas, TX (US); Timothy E. Wiltgen, Addison, TX (US)

(73) Assignee: BAE SYSTEMS Information and Electronic Systems Integration Inc., Nashua, NH (US)

(21) Appl. No.: 18/387,181

(22) Filed: Nov. 6, 2023

(51) Int. Cl. H04B 1/00; H04B 1/04

(52) U.S. Cl. CPC H04B 1/006; H04B 1/0483

(57) ABSTRACT

A switch matrix circuit module for routing signals. In an example, the module includes a switch matrix coupled with first and second switches. The switch matrix is configured to receive a plurality of input signals, and output a selected one of the plurality of input signals as a first intermediate signal and another selected one of the plurality of input signals as a second intermediate signal. The first switch receives the first intermediate signal and a first auxiliary signal, and outputs a first output signal, and the second switch receives the second intermediate signal and a second auxiliary signal, and outputs a second output signal. A number of the modules can be coupled together to provide a switch matrix circuit, which can be readily scaled by adding further modules. In an example, the plurality of input signals are radio frequency (RF) signals.

### TECHNICAL FIELD

The present disclosure relates generally to switch matrix topology, and more particularly to modular and scalable switch matrix topology.

### BACKGROUND

Radio frequency (RF) signals are widely used in a number of applications. Often times, RF applications require reconfigurable routing of multiple input signals to various receivers (or multiple output signals to various transmitters). A switch matrix circuit may be employed to implement such reconfigurable routing of the RF signals. For example, a switch matrix circuit may include a plurality of inputs and one or more outputs, where any output may receive any of the input signals. There remain several non-trivial issues with respect to routing circuit for routing RF signals.

### BRIEF DESCRIPTION OF THE DRAWINGS

FIG. 1 illustrates a plurality of switch matrix modules arranged to provide a modular and scalable routing circuit, in accordance with an embodiment of the present disclosure.

FIG. 2 illustrates an example switch matrix of a switch matrix module of FIG. 1, in accordance with an embodiment of the present disclosure.

FIG. 3 illustrates another modular and scalable routing circuit that includes two switch matrix modules including two corresponding switch matrices, in accordance with an embodiment of the present disclosure.

FIG. 4 illustrates another modular and scalable routing circuit that includes five switch matrix modules including five switch matrices, in accordance with an embodiment of the present disclosure.

FIG. 5 illustrates another modular and scalable routing circuit that includes three output modules, in accordance with an embodiment of the present disclosure.

FIG. 6 illustrates yet another modular and scalable routing circuit that includes five switch matrix modules and three output modules, in accordance with an embodiment of the present disclosure.

FIG. 7 illustrates a flowchart depicting a method of operating a modular and scalable routing circuit, such as any of the circuits of FIG. 1-6, in accordance with an embodiment of the present disclosure.

The figures depict various embodiments of the present disclosure for purposes of illustration only and are not necessarily drawn to scale. Numerous variations, configurations, and other embodiments will be apparent from the following detailed discussion.

### DETAILED DESCRIPTION

A switch matrix circuit module for routing signals, as well as a routing circuit for routing electrical signals using a plurality of switch matrix modules, are described herein. In an example, the switch matrix modules have same topology and design, and are interchangeable. The routing circuit is readily scalable, as additional switch matrix modules may be added to the routing circuit, thereby increasing a number of input signals to the routing circuit, without necessitating significant design changes. The switch matrix circuit module and routing circuit can be used to route any electrical signal, and are especially advantageous for routing RF signals. For example, the switch matrix circuit module and routing circuit can be used to minimize or otherwise reduce a number of switch matrices through which an RF signal has to propagate, thereby reducing signal degradation of the RF signal.

In an example, each switch matrix module comprises a corresponding switch matrix configured to receive a corresponding plurality of input signals, and output one or more intermediate signals. Each switch matrix module further comprises a corresponding plurality of switches, where each such switch is configured to receive an intermediate signal from a corresponding switch matrix, and an auxiliary signal. In an example, for a first switch, a corresponding auxiliary signal may be input to the routing circuit, and for a second switch, the corresponding auxiliary signal may be generated by another switch. In an example, two or more switches may be coupled in series or in a daisy chained manner. The switches selectively generate one or more output signals, such that an output signal can receive any of a plurality of input signals of the routing circuit. As will be described herein below, such configuration of the switches allows for a scalable and modular routing circuit with reduced number of switch matrices through which the input signals have to propagate.

In one embodiment, a switch matrix circuit for routing signals comprises a first switch matrix configured to receive a first plurality of input signals, and output a first intermediate signal. The switch matrix circuit further comprises a second switch matrix configured to receive a second plurality of input signals, and output a second intermediate signal. The switch matrix circuit further comprises a first switch configured to receive (i) the second intermediate signal from the second switch matrix and (ii) a first auxiliary signal, and output a second auxiliary signal. The switch matrix circuit further comprises a second switch configured to receive (i) the first intermediate signal from the first switch matrix and (ii) the second auxiliary signal from the first switch, and output an output signal. In an example, the first and second plurality of input signals are RF signals. Numerous variations and embodiments will be apparent in light of the present disclosure.

### General Overview

As indicated above, there remain several non-trivial issues with respect to routing RF signals. For example, a routing circuit may have a plurality of input signals, and one or more output signals, wherein an output signal can be same as any of the plurality of input signals. A switch matrix is used in the routing circuit. When a large number of input signals are input to the routing circuit, more than one switch matrix, such as a series coupled switch matrix combination (or a rather complex switch matrix), may be used to route the signals, where a signal may have to propagate through more than one switch matrix within the routing circuit. However, performance of a RF signal may degrade, e.g., when the RF signal passes through multiple switch matrices (e.g., due to a switch matrix including a number of RF amplifiers, RF attenuators, and/or RF equalizers, which degrades RF performance).

Accordingly, techniques are described herein to form a routing circuit for routing electrical signals using a plurality of switch matrix modules. Each switch matrix module comprises a corresponding switch matrix. In an example, the switch matrix modules are coupled in a daisy chain manner, such that an input signal passes through a single switch matrix of the routing circuit. In an example, the switch matrix modules have same topology and design, and are interchangeable. The routing circuit is scalable, such that additional modules may be added to handle a relatively large number of input signals, without necessitating an RF signal to propagate through more than one switch matrix. Because the RF signals propagate through a single switch matrix, degradation of RF signals due to propagation through multiple switch matrices is avoided. The routing circuit described herein can be used to route any electrical signals, and is especially advantageous to route RF signals.

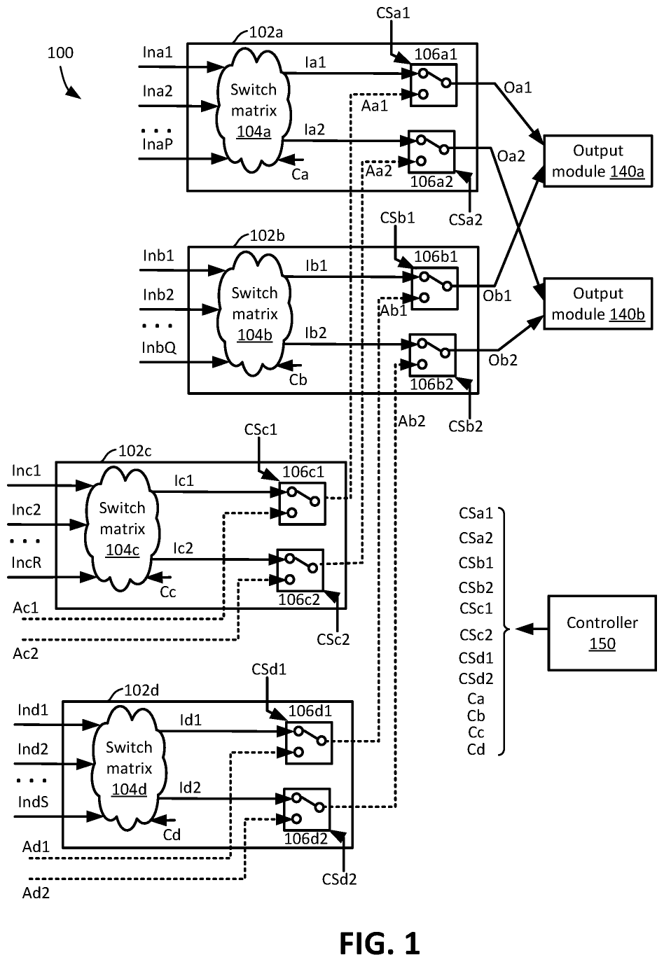

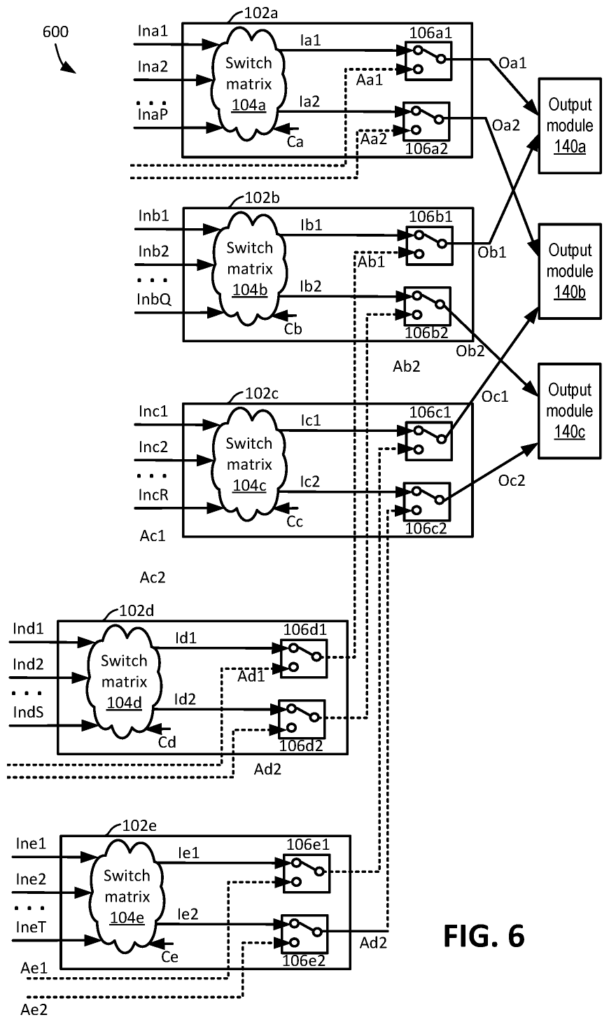

As will be described below in further detail, in an example, each switch matrix module comprises a corresponding switch matrix configured to receive a corresponding plurality of input signals, and output one or more intermediate signals. In an example, a number of intermediate signals may be equal to a number of output modules of the routing circuit (such as in FIGS. 1 and 3-5) or less than a number of output modules of the routing circuit (such as in FIG. 6).

In an example, the switch matrix may operate in an active state or a passive state. In the active state, the switch matrix generates an intermediate signal to be a corresponding selected one of a plurality of input signals received by the switch matrix. In the passive state, the intermediate signal may be electrically floating or grounded. A control signal to a switch matrix controls an operational state of the switch matrix, e.g., controls whether the switch matrix is to operate in the active or passive state, and also controls which of the input signals is to be output as an intermediate signal when operating in the active mode.

Each switch matrix module further comprises a corresponding plurality of switches. In an example, a number of switches within a switch matrix module is equal to a number of intermediate signals generated by the switch matrix module. Within a switch matrix module, a corresponding switch is configured to receive an intermediate signal from the corresponding switch matrix, and an auxiliary signal.

In an example, for a given switch, a corresponding auxiliary signal may be input to the routing circuit. In such an example, the auxiliary signal may be a dummy signal, an electrically floating signal, an electrically grounded signal, or may be an input signal that may be routed to the output module(s). In an example, for another given switch, the corresponding auxiliary signal may be generated by yet another switch.

In an example, switches of two or more switch matrix modules may be coupled in a daisy chained manner (such as switches 106c1 and 106a1 of FIG. 1). For example, an auxiliary signal output by a first switch may be provided to a second switch, where the first and second switches are coupled in the daisy chained manner. For example, assume that the first switch is part of a first switch matrix module having a first plurality of input signals, and the second switch is part of a second switch matrix module having a second plurality of input signals. As will be described below, the daisy chained coupling of the first and second switches allows the second switch to output any of the first or second plurality of input signals of the first and second switch matrix modules, respectively. Thus, any of the first and second plurality of input signals can be routed as an output signal, and each of the first and second plurality of input signals are propagated through a single corresponding switch matrix (e.g., the first plurality of input signals are routed through the first switch matrix, and the second plurality of input signals are routed through the second switch matrix). Thus, as the input signals are routed through only one corresponding switch matrix before reaching the output, this reduces performance degradation of RF signals due to propagation through multiple switch matrices.

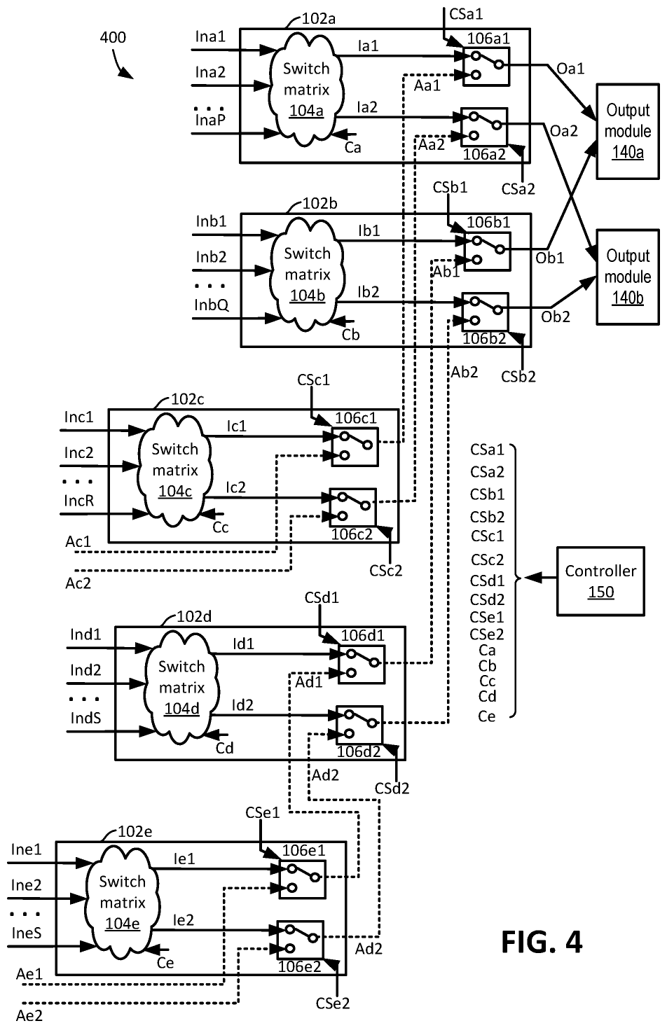

Note that in addition to the above described example of the first and second switches, additional switches may also be added to the daisy chain (e.g., FIG. 4 illustrates three daisy chained switches 106e1, 106d1, 106a1). Thus, the routing circuit is highly scalable, and additional input signals may be handled by the routing circuit by adding additional switch matrix modules, and at the same time without requiring the input signals to propagate through more than one switch matrix module. Numerous variations and embodiments will be apparent in light of the present disclosure.

As used herein, the term “about” indicates that the value listed may be somewhat altered or otherwise within an acceptable tolerance, as long as the alteration does not result in nonconformance of the process or device. For example, for some elements the term “about” can refer to a variation of ±0.1%, for other elements, the term “about” can refer to a variation of ±1% or ±10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a signal that is “substantially” the same as another signal would be either the same as the other signal, or so nearly the same as the other signal that any difference in signal characteristics are negligible for the given application.

### Architecture

FIG. 1 illustrates a modular and scalable routing circuit 100 (also referred to herein as circuit 100), in accordance with an embodiment of the present disclosure. The circuit 100 includes a plurality of switch matrix modules 102a, 102b, 102c, 102d (referred to generally as modules 102 in plural, and module 102 in singular), which may be identical to each other in one example.

Although four modules 102a, . . . , 102d are illustrated in the example of FIG. 1, the circuit 100 may include any different number of such modules, examples of which will be described below.

Each module 102 receives a corresponding plurality of input signals. For example, module 102a receives input signals Ina1, Ina2, . . . , InaP, e.g., “P” number of input signals, where P is a positive integer. Similarly, module 102b receives input signals Inb1, Inb2, . . . , InbQ; module 102c receives input signals Inc1, Inc2, . . . , IncR; and module 102b receives input signals Ind1, Ind2, . . . , IndS. Thus, modules 102a, 102b, 102c, and 102d receive P, Q, R, and S number of corresponding input signals, respectively. In an example, P, Q, R, and S are equal to each other, such that the modules 102a, 102b, 102c, and 102d receive a same number of input signals. In such an example, the modules 102 may be identical to each other. In another example, however, at least one of P, Q, R, and S may be different from another.

The input signals are generally labelled with a prefix of “In,” which may imply any of the input signals Ina1, . . . , IndS to any of the modules 102a, . . . , 102d. Also, input signal Ina would imply any of the input signals to specifically the module 102a (such as any of the input signals Ina1, . . . , InaP); input signal Inb would imply any of the input signals to specifically the module 102b (such as any of the input signals Inb1, . . . , InbQ), and so on.

The circuit 100 includes a plurality of output modules 140a, 140b. In the example of FIG. 1, two output modules are illustrated, although the circuit 100 may include any different number of output modules, examples of which will be described below. The output module 140a receives output signal Oa1 from the module 102a, and receives output signal Ob1 from the module 102b. The output module 140b receives output signal Oa2 from the module 102a, and receives output signal Ob2 from the module 102b.

The circuit 100 can route any of the input signals Ina1, . . . , IndS to any of the output modules 140a, 140b. Merely as an example, the circuit 100 can route input signal Inb2 (e.g., as output signal Ob1) to output module 140a; and can route input signal Ind1 (e.g., as output signal Ob2) to output module 140b. In another example, the circuit 100 can route input signal Inc1 to both output modules 140a and 140b. Thus, any input signal Ina1, . . . , IndS can be routed to any of the output modules 140a, 140b.

In an example, the circuit 100 includes a controller 150 generating control signals CSa1, CSa2, CSb1, CSb2, CSc1, CSc2, CSd1, CSd2, Ca, Cb, Cc, and Cd, which control operations of the respective modules 102a, . . . , 102d, based on which the circuit 100 provides the above described routing functionality, as will be described below.

As illustrated in FIG. 1, each module 102 includes a corresponding switch matrix 104. For example, module 102a includes switch matrix 104a, module 102b includes switch matrix 104b, module 102c includes switch matrix 104c, and module 102d includes switch matrix 104d.

The switch matrix 104a receives the input signals Ina1, . . . , InaP, which are input signals to the module 102a. The switch matrix 104a generates two intermediate signals Ia1 and Ia2, based on the input signals Ina1, . . . , InaP. For example, the switch matrix 104a outputs a selected one of the input signals Ina1, . . . , InaP as the intermediate signal Ia1, and outputs another selected one of the input signals Ina1, . . . , InaP as the intermediate signal Ia2. The intermediate signals Ia1 and Ia2 may be the same (e.g., if the same input signal is selected for both the intermediate signals by the switch matrix 104a), or may be different (e.g., if different input signals are selected for the two intermediate signals by the switch matrix 104a).

In an example, the switch matrix 104a may be in an active state or a passive state. In the active state, the switch matrix 104a generates one or both the intermediate signals Ia1 and Ia2, to be a corresponding selected one of the input signals Ina1, . . . , InaP. In the passive state, the switch matrix 104a need not generate any of the intermediate signals Ia1 and Ia2. Thus, in the passive state, the switch matrix 104a may not generate any of the intermediate signals Ia1 and Ia2, in which case the corresponding intermediate signal line of the intermediate signal Ia1 and/or Ia2 may be electrically floating or grounded. Thus, switches within the switch matrix 104a may be turned off or enter a low power mode, thereby saving power. In another example, in the passive state, the switch matrix 104a may provide an arbitrary input signal to the intermediate signal Ia1 and/or Ia2.

In an example, the control signal Ca, which is output by the controller 150, controls an operational state of the switch matrix 104a. For example, the control signal Ca controls whether the switch matrix 104a is to operate in the active or passive state. Also, if the switch matrix 104a is to operate in the active state, the control signal Ca controls which of the input signals Ina1, . . . , InaP are to be output as the intermediate signals Ia1 and/or Ia2.

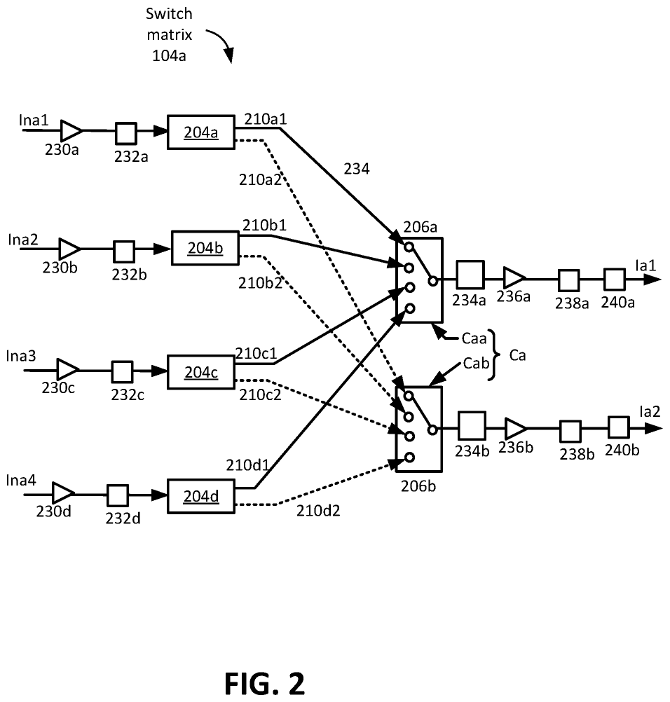

For example, the control signal Ca dictates which of the input signals Ina1, . . . , InaP is to be output as the intermediate signal Ia1 (during an active state of the switch matrix 104a), or whether the signal line of the intermediate signal Ia1 may be electrically floating or grounded (during a passive state of the switch matrix 104a). Similarly, the control signal Ca also dictates which of the input signals Ina1, . . . , InaP is to be output as the intermediate signal Ia2, or whether the signal line of the intermediate signal Ia2 may be electrically floating or grounded. Note that in an example, the control signal Ca may include two control signals Caa and Cab, where Caa controls the output of the intermediate signal Ia1 and where Cab controls the output of the intermediate signal Ia2, as illustrated in FIG. 2.

The switch matrices 104b, 104c, and 104d operate in a similar manner, e.g., similar to the above described operation of the switch matrix 104a. For example, the switch matrix 104b receives the input signals Inb1, . . . , InbQ, which are input signals to the module 102b. The switch matrix 104b generates two intermediate signals Ib1 and Ib2, based on the input signals Inb1, . . . , InbQ. For example, the switch matrix 104b outputs a selected one of the input signals Inb1, . . . , InbQ as the intermediate signal Ib1, and/or outputs another selected one of the input signals Inb1, . . . , InbQ as the intermediate signal Ib2, e.g., during an active state of the switch matrix 104b. In another example, the intermediate signals Ib1 and/or Ib2 may be electrically floating or grounded, e.g., during a passive state of the switch matrix 104b. In an example, the control signal Cb, which is output by the controller 150, controls an operation of the switch matrix 104b. In an example, the circuit and topology of the switch matrices 104a, . . . , 104d may be the same. Operations of the switch matrices 104c and 104d would be apparent, based on the above description of the operations of the switch matrices 104a and 104b.

FIG. 2 illustrates an example switch matrix 104a of the routing circuit 100 of FIG. 1, in accordance with an embodiment of the present disclosure. In the example of FIG. 2, four input signals Ina1, Ina2, Ina3, and Ina4 and two intermediate signals Ia1 and Ia2 are illustrated, although the any different number of input and intermediate signals may be possible. In an example, the switch matrices 104b, . . . , 104d may have a similar topology as the switch matrix 104a depicted in FIG. 2.

The switch matrix 104a comprises a plurality of signal dividers 204a, 204b, 204c, 204d, where each signal divider 204 (also generally referred to herein as dividers 204 in plural, and divider 204 in singular) is configured to receive a corresponding input signal. For example, the signal divider 204a receives the input signal Ina1, the signal divider 204b receives the input signal Ina2, and so on. Thus, a number of signal dividers 204 in the switch matrix 104a is equal to a number of the input signals Ina1, . . . , Ina4, in an example.

The signal dividers 204 are signal splitters. For example, each signal divider 204 divides the corresponding input signal Ina into a number of divided signals 210, where a number of divided signals 210 output by each signal divider 204 is equal to a number of the intermediate signals Ia1 and Ia2. For example, signal divider 204a divides the corresponding input signal Ina1 into divided signals 210a1 and 210a2; signal divider 204b divides the corresponding input signal Ina2 into divided signals 210b1 and 210b2, and so on. Divided signals 210a2, 210b2, 210c2, and 210d2 are illustrated using dotted lines, for purposes of illustrative clarity. A divided signal 210 has substantially same characteristics as the corresponding input signal Ina, e.g., is substantially a copy of the corresponding input signal. For example, the divided output signals 210a1, 210a2 are substantially the same (e.g., substantially same phase and amplitude) as the corresponding input signal Ina1.

The switch matrix 104a further comprises a plurality of switches 206a, 206b. For example, a number of the switches 206a, 206b may correspond to a number of intermediate signals Ia1 and Ia2. As illustrated in FIG. 2, each switch 206 is configured to receive a corresponding divided signal 210 from each of the signal dividers 204. For example, the switch 206a receives divided signal 210a1 from signal divider 204a, divided signal 210b1 from signal divider 204b, divided signal 210c1 from signal divider 204c, and divided signal 210d1 from signal divider 204d. Similarly, the switch 206b receives divided signals 210a2, 210b2, 210c2, and 210d2 from signal dividers 204a, 204b, 204c, 204d, respectively.

In an example, in the active state of the switch matrix 104a, the control signal Ca controls the switching the switches 206a and 206b. For example, if input signal Ina1 is intended for the intermediate signal Ia1, then the switch 206a couples Ia1 to signal 210a1. Thus, Ia1 can be a selected one of the input signals Ina1, . . . , Ina4, and similarly, Ia2 can be a selected one of the input signals Ina1, . . . , Ina4, where the selection is based on the control signal Ca. Note that in an example, the control signal Ca may include two control signals Caa and Cab, where Caa controls the switch 206a and the output of the intermediate signal Ia1; and where Cab controls the switch 206b and output of the intermediate signal Ia2, as illustrated in FIG. 2.

In an example, in the passive state of the switch matrix 104a, the signal dividers 204a, . . . , 204d and/or the switches 206a, 206b may be in a low power or sleep state. In such an example, the intermediate signals Ia1, Ia2 may be electrically floating or may be grounded. In another example, in the passive state of the switch matrix 104a, arbitrary ones of the input signals Ina1, . . . , Ina4 may be output as the intermediate signals Ia1, Ia2.

In one embodiment, the switch matrix 104a also includes a plurality of amplifiers (such as RF amplifiers), e.g., amplifiers 230a, 230b, 230c, 236a, 236b. In one embodiment, the switch matrix 104a also includes a plurality of equalizers (such as RF equalizers), e.g., equalizers 232a, 232b, 232c, 234a, 234b, 240a, 240b. In one embodiment, the switch matrix 104a also includes a plurality of attenuators (such as RF attenuators), e.g., attenuators 238a, 238b.

In an example, because a RF signal has to pass through such a large number of amplifiers, equalizers, and/or attenuators within the switch matrix 104a, a performance of the RF signal degrades each time the RF signal propagates through a switch matrix, such as the switch matrix 104a of FIG. 2. As will be described below, the circuit 100 of FIG. 1 reduces a number of switch matrix through which an input signal has to propagate before reaching the output modules 140. For example, in the circuit 100, an input signal has to propagate through only one switch matrix, irrespective of a number of input signals received by the circuit 100.

Referring again to FIG. 1, each module 102 includes two corresponding switches 106. For example, the module 102a includes switches 106a1 and 106a2, the module 102b includes switches 106b1 and 106b2, the module 102c includes switches 106c1 and 106c2, and the module 102d includes switches 106d1 and 106d2, as illustrated in FIG. 1.

Each switch 106 receives a corresponding intermediate signal and a corresponding auxiliary signal. For example, switch 106a1 receives intermediate signal Ia1 and auxiliary signal Aa1, and switch 106a2 receives intermediate signal Ia2 and auxiliary signal Aa2. Similarly, switch 106b1 receives intermediate signal Ib1 and auxiliary signal Ab1, and switch 106b2 receives intermediate signal Ib2 and auxiliary signal Ab2. Similarly, switch 106c1 receives intermediate signal Ic1 and auxiliary signal Ac1, and switch 106c2 receives intermediate signal Ic2 and auxiliary signal Ac2. Similarly, switch 106d1 receives intermediate signal Id1 and auxiliary signal Ad1, and switch 106d2 receives intermediate signal Id2 and auxiliary signal Ad2. The signal lines for various auxiliary signals are illustrated using dotted lines, for purposes of illustrative clarity.

As illustrated in FIG. 1, the auxiliary signal Aa1 is generated by the switch 106c1. Similarly, auxiliary signals Aa2, Ab1, and Ab2 are respectively generated by the switches 106c2, 106d1, and 106d2, as will be described below.

The auxiliary signals Ac1, Ac2, Ad1, Ad2 are received by the circuit 100. These auxiliary signals Ac1, Ac2, Ad1, Ad2 may be dummy signals, such as electrically floating signals or are electrically grounded, in one example. In another example, additional input signals (e.g., in addition to the input signals Ina1, . . . , IndS) may be input as the auxiliary signals Ac1, Ac2, Ad1, Ad2.

In operation, in an example, assume that the input signals Ina1 and Inc2 are to be output to the output modules 140a, 140b, respectively. In such a case, the switch matrix 104a outputs input signal Ina1 as the intermediate signal Ia1. Switch 106a1 receives the intermediate signal Ia1 (which is the input signal Ina1) and the auxiliary signal Aa1. The auxiliary signal Aa1 generated by the switch 106c1 isn't relevant for this scenario, and the auxiliary signal Aa1 can be (i) any arbitrary one of the input signals Inc1, . . . , IncR, (ii) the auxiliary signal Ac1, or (iii) an electrically floating or electrically grounded signal. The switch 106a1 couples the intermediate signal Ia1 (which is the input signal Ina1) to the output signal Oa1, such that the output signal Oa1 is same as the input signal Ina1, which is then received by the output module 140a.

Furthermore, continuing with the above example, the input signal Inc2 is to be output to the output module 140a. The switch matrix 104c outputs input signal Inc2 as the intermediate signal Ic2. Switch 106c2 receives the intermediate signal Ic2 (which is the input signal Inc2) and the auxiliary signal Ac2 (where the auxiliary signal Ac2 can be a dummy signal, can be grounded or electrically floating, or can be another input signal). The switch 106c2 outputs the intermediate signal 1c2 (which is the input signal Inc2) as the auxiliary signal Aa2. The switch 106a2 receives the intermediate signal Ia2 and the auxiliary signal Aa2 (which is the input signal Inc2). Note that the intermediate signal Ia2 can be any of the input signals Ina1, . . . , InaP, or may be electrically floating or electrically grounded. The switch 106a2 couples the auxiliary signal Aa2 (which is the input signal Inc2) to the output signal Oa2 received by the output module 140b, thereby transmitting the input signal Inc2 to the output module 140b.

Note that in the above example where the input signals Ina1 and Inc2 are to be output to the output modules 140a, 140b, respectively, the intermediate signals Ia2, Ib1, Ib2, Ic1, Id1, and Id2 may be electrically floating or be grounded (e.g., portions of the corresponding switch matrices may be in the passive state described above).

Similarly, in another example, assume that the input signals Inb1 and Ind1 are to be output to the output modules 140a, 140b, respectively. In such a case, the input signal Inb1 is transmitted to the output module 140a through the switch matrix 104b to the switch 106b1, and then to the output module 140a. Also, the input signal Ind1 is transmitted to the output module 140b through the switch matrix 104d to the switch 106d2 (e.g., as the intermediate signal Id2), then to the switch 106b2, and then to the output module 140b. Note that in this example, the intermediate signals Ia1, Ia2, Ib2, Ic1, Ic2, and Id1 may be electrically floating or be grounded (e.g., portions of the corresponding switch matrices may be in the passive state described above).

In a further example, assume that the input signal Ind1 is to be output to both the output modules 140a, 140b. In such an example, both the intermediate signals Id1 and Id2 comprise the input signal Ind1. Intermediate signal Id1 is transmitted to the output module 140a through the switches 106d1 and 106b1. Intermediate signal Id2 is transmitted to the output module 140b through the switches 106d2 and 106b2.

Thus, the circuit 100 can route any of the input signals Ina1, . . . , IndS to any of the output modules 140a, 140b. Furthermore, because the structure and circuitry of the modules 102a, 102b, 102c, 102d are identical, the circuit 100 is scalable. For example, additional inputs can be added to the circuit 100, by adding additional modules similar to the modules 102a, . . . 102d. The circuit 100 is highly modular and scalable.

In an example, one or more of the modules 102a, . . . , 102d, the interconnections between the modules, the output modules 140a, 140b, and/or a controller 150 may be implemented on an integrated circuit die, on a printed circuit board (PCB), or a printed wiring board (PWB). The input signals Ina1, . . . , IndS may be any appropriate type of signals, e.g., having an appropriate frequency. In an example, the input signals Ina1, . . . , IndS may be radio frequency (RF) signals, such as having a frequency in the Giga Hertz (GHz) range. For example, one or more of the switches 106a1, . . . , 106d2 are placed in a daisy-chained fashion. Due to the structure of the circuit 100, any given input signal may pass through a single switch matrix, and need not pass through multiple switch matrices in series. Without the daisy chaining of the switches 106a1, . . . , 106d1 of FIG. 1, multiple series coupled switch matrices may have to be used to route a large number of input signals, resulting in RF performance degradation. In contrast, in the circuit 100, as individual input signal pass through a single switch matrix, this eliminates or at least reduces such RF performance degradation.

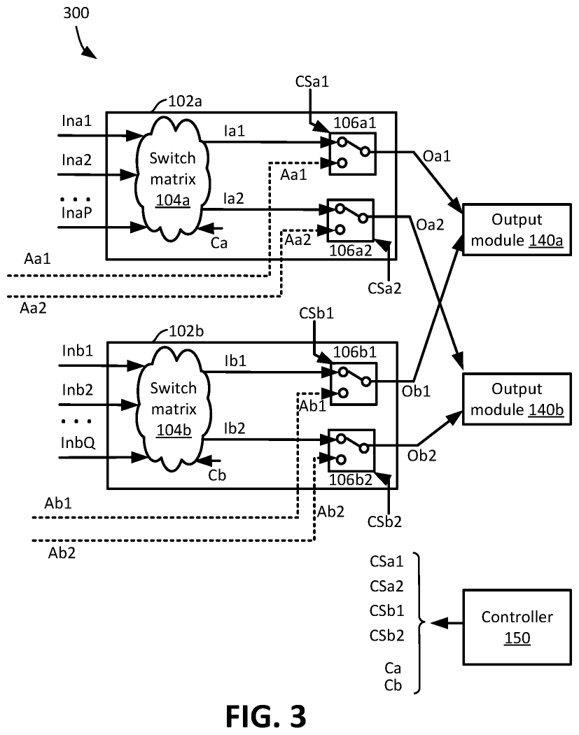

The circuit 100 of FIG. 1 has four modules 102a, 102b, 102c, 102d, and two output modules 140a, 140b. However, the circuit 100 can be scaled to include any different number of modules 102 (and hence, any different number of input signals) and any different number of output modules 140. For example, FIG. 3 illustrates another modular and scalable routing circuit 300 (also referred to herein as circuit 300) that includes two switch matrix modules 102a and 102b including two corresponding switches matrices 104a, 104b, respectively, in accordance with an embodiment of the present disclosure. Like components in FIGS. 1 and 3 are labelled using same labels.

In FIG. 3, there are two modules 102a, 102b, and hence, unlike the circuit 100 of FIG. 1, in the circuit 300 of FIG. 3 the switches 106a1, . . . , 106b2 are not coupled in series or daisy chained. The auxiliary signals Aa1, Aa2, Ab1, Ab2 may be dummy signals, such as electrically floating signals or are electrically grounded, in one example. In another example, additional input signals (e.g., in addition to the input signals Ina1, . . . , InbQ) may be input as the auxiliary signals Aa1, Aa2, Ab1, Ab2. The operation of the circuit 300 will be apparent, based on the above description of the circuit 100 of FIG. 1.

FIG. 4 illustrates another modular and scalable routing circuit 400 (also referred to herein as circuit 400) that includes five switch matrix modules 102a, . . . , 102e including five switch matrices 104a, . . . , 104e, respectively, in accordance with an embodiment of the present disclosure. Like components in FIGS. 1 and 4 are labelled using same labels.

In FIG. 4, there is an additional module 102e, which may be at least in part similar to any of the modules 102a, . . . , 102d of FIG. 1. The switches 106e1, 106d1, and 106b1 are coupled in series or in a daisy chain manner. Similarly, the switches 106e2, 106d2, and 106b2 are coupled in series or in a daisy chain manner.

In an example, assume input signals Ind1 and Ine1 are to be respectively transmitted to the output modules 140a and 140b. The input signal Ind1 is transmitted to the output module 140a through the switch matrix 104d (e.g., which outputs the input signal Ind1 as intermediate signal Id1) and the switches 106d1 and 106b1. The input signal Ine1 is transmitted to the output module 140b through the switch matrix 104e (e.g., which outputs the input signal Ine1 as intermediate signal Ie2) and through the switches 106e2, 106d2, and 106b2. The operation of the circuit 400 will be apparent, based on the above description of the circuit 100 of FIG. 1.

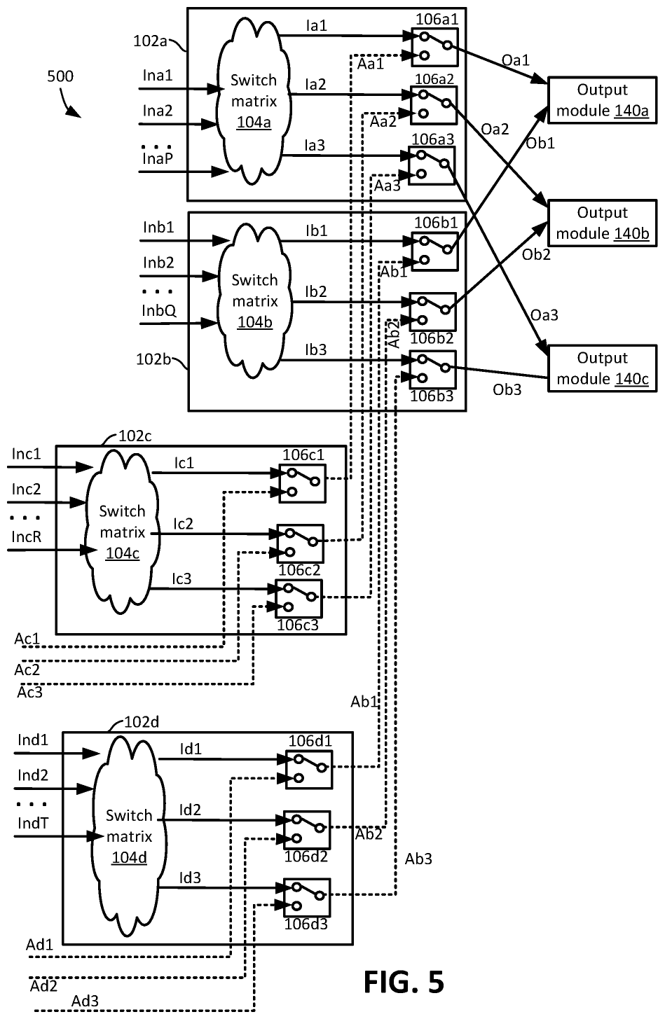

FIG. 5 illustrates another modular and scalable routing circuit 500 (also referred to herein as circuit 500) that includes three output modules 140a, 140b, 140c, in accordance with an embodiment of the present disclosure. For purposes of illustrative clarity, the control signals CSa1, CSa2, etc. are not illustrated in FIG. 5. Like components in FIGS. 1 and 5 are labelled using same labels. Because there are three output modules 140a, 140b, 140c, each module 102 has three corresponding switches 106, such as switches 106a1, 106a2, 106a3 in the module 102a. The circuit 500 will be apparent, based on the above description of the circuit 100 of FIG. 1.

FIG. 6 illustrates yet another modular and scalable routing circuit 600 (also referred to herein as circuit 600) that includes three output modules 140a, 140b, 140c, in accordance with an embodiment of the present disclosure. Comparing the circuits 500 and 600 of FIGS. 5 and 6, respectively, in the circuit 500, each module 102 has three corresponding switches 106 (such as switches 106a1, 106a2, and 106a3 for the module 102a). Accordingly, in circuit 500, any module 102 can transmit any input signal to any output module 140.

In contrast, in the circuit 600 of FIG. 6, each module 102 has two corresponding switches 106 (such as switches 106a1, 106a2 for the module 102a). Accordingly, in circuit 600, a module 102 may transmit input signals to two corresponding output modules 140. For example, module 102a can transmit signals to output modules 140a and 140b, and not to 140c. Thus, input signals Ina1, . . . , InaP can be transmitted to output modules 140a and 140b, and not to 140c. Accordingly, the circuit 600 has less flexibility in routing the input signals compared to the circuit 500. However, the circuit 600 is simpler than the circuit 500, resulting in cost and/or area saving.

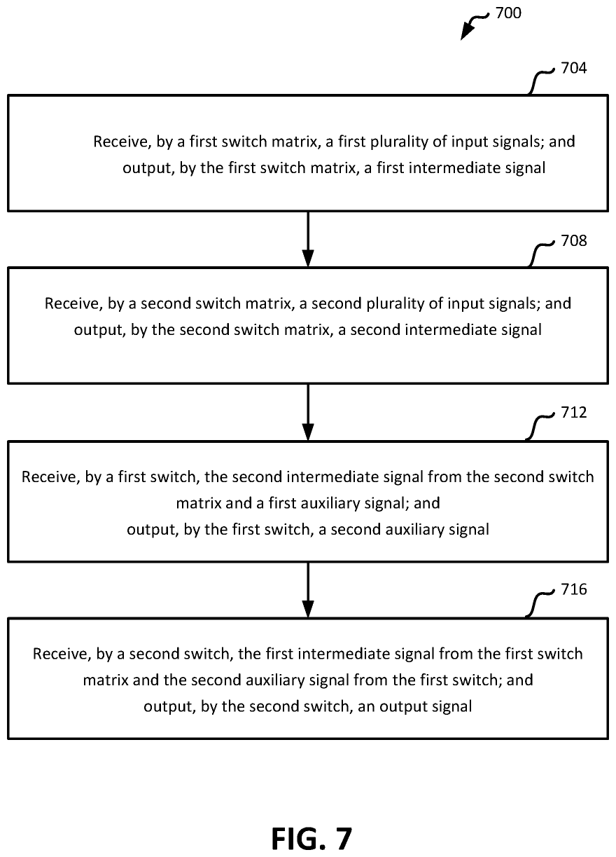

FIG. 7 illustrates a flowchart depicting a method 700 of operating a modular and scalable routing circuit, such as any of the circuits 100-600 of FIG. 1-6, in accordance with an embodiment of the present disclosure.

Referring to FIG. 7, the method 700 includes, at 704, receiving, by a first switch matrix, a first plurality of input signals; and outputting, by the first switch matrix, a first intermediate signal. For example, the switch matrix 104a receives the plurality of input signals Ina1, . . . , InaP, and outputs an intermediate signal Ia1. As described above, the intermediate signal Ia1 can be a selected one of the plurality of input signals Ina1, . . . , InaP (e.g., if the switch matrix 104a is in the active mode), or may be electrically floating or grounded (e.g., if the switch matrix 104a is in the passive mode).

The method 700 proceeds from 704 to 708. At 708, a second switch matrix receives a second plurality of input signals, and outputs a second intermediate signal. For example, the switch matrix 104c receives the plurality of input signals Inc1, . . . , IncR, and outputs an intermediate signal Ic1. As described above, the intermediate signal Ic1 can be a selected one of the plurality of input signals Inc1, . . . , IncR (e.g., if the switch matrix 104c is in the active mode), or may be electrically floating or grounded (e.g., if the switch matrix 104c is in the passive mode).

The method 700 proceeds from 708 to 712. At 712, a first switch receives the second intermediate signal from the second switch matrix and a first auxiliary signal, and outputs a second auxiliary signal. For example, the switch 106c1 receives the intermediate signal Ic1 from the switch matrix 102c and the auxiliary signal Ac1, and outputs another auxiliary signal Aa1.

The method 700 proceeds from 712 to 716. At 716, a second switch receives the first intermediate signal from the first switch matrix and the second auxiliary signal from the first switch, and outputs an output signal. For example, the switch 106a1 receives the intermediate signal ia1 from the switch matrix 104a and the auxiliary signal Aa1 from the switch 104c, and outputs the output signal Oa1.

Note that the processes in method 700 are shown in a particular order for ease of description. However, one or more of the processes may be performed in a different order or may not be performed at all (and thus be optional), in accordance with some embodiments. Numerous variations on method 700 and the techniques described herein will be apparent in light of this disclosure.

### FURTHER EXAMPLE EMBODIMENTS

The following examples pertain to further embodiments, from which numerous permutations and configurations will be apparent.

Example 1. A circuit comprising: a first switch matrix configured to receive a first plurality of input signals, and output a first intermediate signal; a second switch matrix configured to receive a second plurality of input signals, and output a second intermediate signal; a first switch configured to receive (i) the second intermediate signal from the second switch matrix and (ii) a first auxiliary signal, and output a second auxiliary signal; and a second switch configured to receive (i) the first intermediate signal from the first switch matrix and (ii) the second auxiliary signal from the first switch, and output an output signal.

Example 2. The circuit of example 1, further comprising: a third switch matrix configured to receive a third plurality of input signals, and output a third intermediate signal; and a third switch configured to receive (i) the third intermediate signal from the third switch matrix and (ii) a third auxiliary signal, and output the first auxiliary signal that is received by the second switch.

Example 3. The circuit of any one of examples 1-2, wherein the first switch matrix is further configured to output a third intermediate signal, wherein the second switch matrix is further configured to output a fourth intermediate signal, wherein the output signal is a first output signal, and wherein the circuit further comprises: a third switch configured to receive (i) the fourth intermediate signal from the second switch matrix and (ii) a third auxiliary signal, and output a fourth auxiliary signal; and a fourth switch configured to receive (i) the third intermediate signal from the first switch matrix and (ii) the fourth auxiliary signal from the third switch, and output a second output signal.

Example 4. The circuit of example 3, wherein the first switch matrix is further configured to output a fifth intermediate signal, wherein the second switch matrix is further configured to output a sixth intermediate signal, and wherein the circuit further comprises: a fifth switch configured to receive (i) the sixth intermediate signal from the second switch matrix and (ii) a fifth auxiliary signal, and output a sixth auxiliary signal; and a sixth switch configured to receive (i) the fifth intermediate signal from the first switch matrix and (ii) the sixth auxiliary signal from the fifth switch, and output a third output signal.

Example 5. The circuit of any one of examples 3-4, wherein the first switch matrix and the second and fourth switches provide a first switch matrix module, and the second switch matrix and the first and third switches provide a second switch matrix module, wherein the first and second switch matrix modules have the same design.

Example 6. The circuit of any one of examples 1-5, wherein the output signal is a first output signal received by an output module, and wherein the circuit further comprises: a third switch matrix configured to receive a third plurality of input signals, and output a third intermediate signal; a fourth switch matrix configured to receive a fourth plurality of input signals, and output a fourth intermediate signal; a third switch configured to receive (i) the fourth intermediate signal from the fourth switch matrix and (ii) a third auxiliary signal, and output a fourth auxiliary signal; and a fourth switch configured to receive (i) the third intermediate signal from the third switch matrix and (ii) the fourth auxiliary signal from the third switch, and output a second output signal to the output module.

Example 7. The circuit of any one of examples 1-6, wherein the first switch matrix is configured to output a selected one of the first plurality of input signals as the first intermediate signal, or to allow the first intermediate signal to be electrically floating, or to output a ground signal as the first intermediate signal.

Example 8. The circuit of any one of examples 1-7, wherein the second switch matrix is configured to output a selected one of the second plurality of input signals as the second intermediate signal, or to allow the second intermediate signal to be electrically floating, or to output a ground signal as the second intermediate signal.

Example 9. The circuit of any one of examples 1-8, wherein: the first switch is configured to output a selected one of the second intermediate signal or the first auxiliary signal as the second auxiliary signal; and the second switch is configured to output a selected one of the first intermediate signal or the second auxiliary signal as the output signal.

Example 9a. The circuit of any of claims 1-9, wherein the first auxiliary signal is an electrically floating signal or an electrically grounded signal.

Example 10. The circuit of any one of examples 1-9a, wherein the first and second plurality of input signals are radio frequency (RF) signals.

Example 11. A printed circuit board (PCB) or printed wiring board (PWB) comprising the circuit of any one of examples 1-10.

Example 12. A method comprising: receiving, by a first switch matrix, a first plurality of input signals; outputting, by the first switch matrix, a first intermediate signal; receiving, by a second switch matrix, a second plurality of input signals; outputting, by the second switch matrix, a second intermediate signal; receiving, by a first switch, the second intermediate signal from the second switch matrix and a first auxiliary signal; outputting, by the first switch, a second auxiliary signal; receiving, by a second switch, the first intermediate signal from the first switch matrix and the second auxiliary signal from the first switch; and outputting, by the second switch, an output signal.

Example 13. The method of example 12, further comprising: receiving, by a third switch matrix, a third plurality of input signals; outputting, by the third switch matrix, a third intermediate signal; receiving, by a third switch, the third intermediate signal from the third switch matrix and a third auxiliary signal; and outputting, by the third switch, the first auxiliary signal that is received by the first switch.

Example 14. The method of any one of examples 12-13, wherein: outputting, by the first switch matrix, the first intermediate signal comprises outputting a selected one of the first plurality of input signals as the first intermediate signal; and outputting, by the second switch matrix, the second intermediate signal comprises outputting a selected one of the second plurality of input signals as the second intermediate signal.

Example 15. The method of any one of examples 12-14, wherein: outputting, by the first switch, the second auxiliary signal comprises outputting a selected one of the second intermediate signal or the first auxiliary signal as the second auxiliary signal; and outputting, by the second switch, the output signal comprises outputting a selected one of the first intermediate signal or the second auxiliary signal as the output signal.

Example 16. The method of any one of examples 12-15, wherein the first and second plurality of input signals are radio frequency (RF) signals.

Example 17. A circuit comprising: a switch matrix configured to receive a plurality of input signals, and output (i) a selected one of the plurality of input signals as a first intermediate signal and (i) another selected one of the plurality of input signals as a second intermediate signal; a first switch to receive the first intermediate signal and a first auxiliary signal, and output a first output signal; and a second switch to receive the second intermediate signal and a second auxiliary signal, and output a second output signal.

Example 18. The circuit of example 18, wherein the switch matrix is a first switch matrix, the plurality of input signals is a first plurality of input signals, and wherein the circuit further comprises: a second switch matrix configured to receive a second plurality of input signals, and output a selected one of the second plurality of input signals as a third intermediate signal; and a third switch to receive the third intermediate signal and a third auxiliary signal, and output the first auxiliary signal that is received by the first switch.

Example 19. The circuit of example 18, wherein the third auxiliary signal is an electrically floating signal, is a ground signal, or is a radio frequency (RF) input signal.

Example 20. The circuit of any one of examples 18-19, further comprising: a third switch matrix and a fifth switch configured to generate the third auxiliary signal.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A circuit comprising:
a first switch matrix configured to receive a first plurality of input signals, and output a first intermediate signal;
a second switch matrix configured to receive a second plurality of input signals, and output a second intermediate signal;
a first switch configured to receive (i) the second intermediate signal from the second switch matrix and (ii) a first auxiliary signal, and output a second auxiliary signal; and
a second switch configured to receive (i) the first intermediate signal from the first switch matrix and (ii) the second auxiliary signal from the first switch, and output an output signal.

2. The circuit of claim 1, further comprising:
a third switch matrix configured to receive a third plurality of input signals, and output a third intermediate signal; and
a third switch configured to receive (i) the third intermediate signal from the third switch matrix and (ii) a third auxiliary signal, and output the first auxiliary signal that is received by the second switch.

3. The circuit of claim 1, wherein the first switch matrix is further configured to output a third intermediate signal, wherein the second switch matrix is further configured to output a fourth intermediate signal, wherein the output signal is a first output signal, and wherein the circuit further comprises:
a third switch configured to receive (i) the fourth intermediate signal from the second switch matrix and (ii) a third auxiliary signal, and output a fourth auxiliary signal; and
a fourth switch configured to receive (i) the third intermediate signal from the first switch matrix and (ii) the fourth auxiliary signal from the third switch, and output a second output signal.

4. The circuit of claim 3, wherein the first switch matrix is further configured to output a fifth intermediate signal, wherein the second switch matrix is further configured to output a sixth intermediate signal, and wherein the circuit further comprises:
a fifth switch configured to receive (i) the sixth intermediate signal from the second switch matrix and (ii) a fifth auxiliary signal, and output a sixth auxiliary signal; and
a sixth switch configured to receive (i) the fifth intermediate signal from the first switch matrix and (ii) the sixth auxiliary signal from the fifth switch, and output a third output signal.

5. The circuit of claim 3, wherein the first switch matrix and the second and fourth switches provide a first switch matrix module, and the second switch matrix and the first and third switches provide a second switch matrix module, wherein the first and second switch matrix modules have the same design.

6. The circuit of claim 1, wherein the output signal is a first output signal received by an output module, and wherein the circuit further comprises:
a third switch matrix configured to receive a third plurality of input signals, and output a third intermediate signal;
a fourth switch matrix configured to receive a fourth plurality of input signals, and output a fourth intermediate signal;
a third switch configured to receive (i) the fourth intermediate signal from the fourth switch matrix and (ii) a third auxiliary signal, and output a fourth auxiliary signal; and
a fourth switch configured to receive (i) the third intermediate signal from the third switch matrix and (ii) the fourth auxiliary signal from the third switch, and output a second output signal to the output module.

7. The circuit of claim 1, wherein the first switch matrix is configured to output a selected one of the first plurality of input signals as the first intermediate signal, or to allow the first intermediate signal to be electrically floating, or to output a ground signal as the first intermediate signal.

8. The circuit of claim 1, wherein the second switch matrix is configured to output a selected one of the second plurality of input signals as the second intermediate signal, or to allow the second intermediate signal to be electrically floating, or to output a ground signal as the second intermediate signal.

9. The circuit of claim 1, wherein:
the first switch is configured to output a selected one of the second intermediate signal or the first auxiliary signal as the second auxiliary signal; and
the second switch is configured to output a selected one of the first intermediate signal or the second auxiliary signal as the output signal.

10. The circuit of claim 1, wherein the first auxiliary signal is an electrically floating signal or an electrically grounded signal.

11. The circuit of claim 1, wherein the first and second plurality of input signals are radio frequency (RF) signals.

12. A printed circuit board (PCB) or printed wiring board (PWB) comprising the circuit of claim 1.

13. A method comprising:
receiving, by a first switch matrix, a first plurality of input signals;
outputting, by the first switch matrix, a first intermediate signal;
receiving, by a second switch matrix, a second plurality of input signals;
outputting, by the second switch matrix, a second intermediate signal;
receiving, by a first switch, the second intermediate signal from the second switch matrix and a first auxiliary signal;
outputting, by the first switch, a second auxiliary signal;
receiving, by a second switch, the first intermediate signal from the first switch matrix and the second auxiliary signal from the first switch; and
outputting, by the second switch, an output signal.

14. The method of claim 13, further comprising:
receiving, by a third switch matrix, a third plurality of input signals;
outputting, by the third switch matrix, a third intermediate signal;
receiving, by a third switch, the third intermediate signal from the third switch matrix and a third auxiliary signal; and
outputting, by the third switch, the first auxiliary signal that is received by the first switch.

15. The method of claim 13, wherein:
outputting, by the first switch matrix, the first intermediate signal comprises outputting a selected one of the first plurality of input signals as the first intermediate signal; and
outputting, by the second switch matrix, the second intermediate signal comprises outputting a selected one of the second plurality of input signals as the second intermediate signal.

16. The method of claim 13, wherein:
outputting, by the first switch, the second auxiliary signal comprises outputting a selected one of the second intermediate signal or the first auxiliary signal as the second auxiliary signal; and
outputting, by the second switch, the output signal comprises outputting a selected one of the first intermediate signal or the second auxiliary signal as the output signal.

17. A circuit comprising:
a switch matrix configured to receive a plurality of input signals, and output (i) a selected one of the plurality of input signals as a first intermediate signal and (i) another selected one of the plurality of input signals as a second intermediate signal;
a first switch to receive the first intermediate signal and a first auxiliary signal, and output a first output signal; and
a second switch to receive the second intermediate signal and a second auxiliary signal, and output a second output signal.

18. The circuit of claim 18, wherein the switch matrix is a first switch matrix, the plurality of input signals is a first plurality of input signals, and wherein the circuit further comprises:
a second switch matrix configured to receive a second plurality of input signals, and output a selected one of the second plurality of input signals as a third intermediate signal; and
a third switch to receive the third intermediate signal and a third auxiliary signal, and output the first auxiliary signal that is received by the first switch.

19. The circuit of claim 18, wherein the third auxiliary signal is an electrically floating signal, is a ground signal, or is a radio frequency (RF) input signal.

20. The circuit of claim 18, further comprising:
a third switch matrix and a fifth switch configured to generate the third auxiliary signal.
